(19) United States
(12) Patent Application Publication
(10) Pub. No.: US 2006/0077418 A1
(43) Pub. Date: Apr. 13, 2006

(54) Image forming system and image forming apparatus

(75) Inventors: Hirofumi Nakajima, Tokyo (JP); Masanobu Kawano, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA BUSINESS TECHNOLOGIES, INC.

(21) Appl. No.: 11/190,123

(22) Filed: Jul. 27, 2005

(30) Foreign Application Priority Data
Aug. 2, 2004 (JP) JP2004-225295
Jun. 29, 2005 (JP) JP2005-189635

(51) Int. Cl. G06K 15/00

(52) U.S. Cl. 358/1.14

(57) ABSTRACT

An image forming system includes an image forming device having an input section for inputting a job, a post-processor for post-processing of a recording medium formed by the image forming device, the post-processor having a heating section and a first temperature detection section for detecting a temperature of the heating section, and a control section that determines whether a job inputted via the input section is executable or not, based on first temperature-related information related to a temperature of the heating section, the temperature being detected by the first temperature detection section, and a content of the inputted job. The control section may be one that decides executable jobs, based on the first temperature related information related to the temperature of the heating section detected by the first temperature detecting section.

### FIELD OF THE INVENTION

The present invention relates to an image forming system including an image forming device and a post-processor having a heating unit and connected to the image forming device, and relates to an image forming device connectable with a post-processor.

### BACKGROUND OF THE INVENTION

There are image forming systems wherein a post-processor having a bookbinding function is connected to an image forming device such as a copying machine or a printer on online basis, and image-formed sheets ejected from the image forming device are bound into a booklet by the post-processor. As a bookbinding method by a bookbinding device constructing such an image forming system, there is a method wherein a tape (binding tape) that is made by coating a hot-melt type adhesive which is softened and melted by heat on a base, such as a sheet of paper or a cloth cut into a tape shape, is pressed against edges of the sheets for binding while the tape is heated, and this method is effective for binding important documents, because there is no restriction of the length of a binding needle unlike bookbinding methods using a binding needle, even when the number of pages is large, and a finished appearance is fine.

Bookbinding by the use of a binding tape is conducted through processes wherein sheets ejected from the image forming device are sequentially stacked and trued up in order to be formed into a bundle of sheets; then, the binding tape is brought into pressure contact with an end surface portion of the bundle of sheets by a heating member for binding; the hot-melt type adhesive on the surface of the binding tape heated and melted is moved to the bundle of sheets; and the heating member is separated. After the heating member is separated, the bundle of sheets and the hot-melt type adhesive of the binding tape return to a normal temperature to be solidified so that the bundle of sheets and the binding tape are fixed together, and bookbinding is completed.

A digital type image forming device, such as a copying machine or a printer is usually equipped with a printer section employing an elelctrophotographic process, and is equipped with a fixing unit that applies heat and pressure on a toner image transferred and formed on a recording medium such as a sheet of paper, and melts and fixes the toner image on the recording medium. A fixing unit is equipped with a heating unit such as a heater including an electro-heating resistor, and is heated up to the temperature (fixing temperature) suitable for fixing a toner image, and after reaching the fixing temperature, the fixing unit is kept at a predetermined temperature to be used for image forming.

In such an image forming device, when the power supply is turned off after a daily operation, current to the heater is cut, and the temperature of the fixing unit drops to an ambient temperature in the installation environment of the image forming device if it is left alone. Therefore, when the device is used again next day, for example, it is necessary to raise the temperature of the fixing unit from the ambient temperature in the installation environment to the fixing temperature, and after the power supply of the image forming device is turned on, a preparatory operation to heat the fixing unit is carried out first. Or, in a case of starting up from an energy-saving mode, such as a power-save mode or a sleep mode, which reduces power consumption during idle time, the fixing unit is heated from the temperature at which the fixing unit has been kept in the energy-saving mode. This preparatory operation is called warm-up, and the time period from the moment of turning on the power supply or of starting from the energy-saving mode to the moment when the fixing unit reaches the fixing temperature is called warm-up time. As the image forming device cannot conduct image forming before the fixing unit reaches the fixing temperature, image forming cannot be carried out when the warm-up is in progress. The image forming device is equipped with a control unit that controls operations, and is controlled by the control unit so that execution of any job in the image forming device is prohibited during warm-up. For a while after a user turns on the power supply or starts operation from the energy-saving mode, the user cannot use the image forming device and has to wait until when the fixing unit reaches the predetermined temperature that enables image forming, namely, until when the warm-up is completed.

In the same way, even in the case of a post-processor having a bookbinding unit with a heating member, such as a bookbinding device using a binding tape, it is necessary to heat the heating member from the time of turning on the power supply or starting operation from the energy-saving mode until when the temperature of the heating member reaches the temperature at which hot-melt adhesive on the binding tape can be melted. The heating member is equipped with an electro-heating resistor such as Nichrome wire as a heater, and when power supply is turned on the post-processor, application of current to the heater is started, and the heating member is heated up to the temperature which makes bookbinding operations possible. Until the temperature of the heating member reaches the predetermined temperature, the hot-melt adhesive cannot be softened, and accordingly the bookbinding device cannot be used. The status from the moment of turning on the power supply or of starting operation from the energy-saving mode to the moment the temperature of the heating member reaches the predetermined temperature that allows bookbinding is called warm-up, and control is performed so that a use of the bookbinding device is prohibited while the warm-up is in progress. Namely, the user cannot use the post-processor until the warm-up of the heating member is completed.

Shortening a waiting period in the warm-up has been an important issue. As a technology to shorten warm-up time of a fixing unit in an image forming device, there are given, for example, a method to calculate a total image area to be formed from sizes and the number of recording media and thereby to set a necessary temperature of the fixing unit to fix the total image area (e.g., see Patent Document 1), a method to calculate an amount of toner consumption from document density by counting the number of dots and thereby to set a fixing temperature (e.g., see Patent Document 2), and a method to improve heating efficiency by reducing heat capacity of a heating member by thinning it and by using a heating method called an electromagnetic inductive heating and fixing method (e.g., see Patent Document 3). As a technology to shorten warm-up time of a bookbinding device, there is given a method to shorten warm-up time by providing plural heating units and by changing the number of heating units depending on the occasion of warm-up and on the occasion of completion of warm-up (e.g., see Patent Document 4).

(Patent Document 1) TOKKAIHEI No. 10-39674

(Patent Document 2) TOKKAIHEI No. 11-125987

(Patent Document 3) TOKKAIHEI No. 7-295414

(Patent Document 4) TOKKAIHEI No. 10-35138

In an image forming system wherein a post-processor is connected to an image forming device, application of current to the post-processor is, in general, started by turning on power supply to the main body of the image forming device, or by starting operation from an energy saving mode. Warm-up of the image forming device and that of the post-processor are started simultaneously by turning on power supply to the main body of the image forming device or by starting operation from the energy-saving mode, and in a known image forming system, control is performed so that execution of any job is prohibited until both warm-ups are completed. In other words, after turning on power supply to the image forming system, or after starting operation from the energy saving mode, the image forming system is in a state of waiting until both warm-ups are completed in the image forming device and in the post-processor, and execution of any job is prohibited in this state. A user has to wait during this state, which is inconvenient, and operation efficiency and productivity of the image forming system are low.

From the viewpoint of shortening as much as possible the time for a user to wait and of improving productivity of an image forming system, it is necessary to take into account management of warm-up as a system. However, any of methods and technologies, as describe above, for shortening the warm-up time are related to the respective warm-ups of the image forming device and the post-processor, and there has not been an image forming system that can integrally manage the warm-ups as a system.

Incidentally, it can be considered that the respective capacities of heaters of an image forming device and a post-processor are increased, and thereby, the warm-up time of each of them is shortened. However, enhancement of the capacities of the heaters requires providing a high electric power, which is limited in terms of realization in equipment or a device restricted in power supplied through a power board or a plug socket to be connected.

An object of the invention is to provide a user friendly image forming system and an image forming device to which a post-processor can be connected.

### SUMMARY OF THE INVENTION

In an aspect of the invention, there is provided an image forming system including an image forming device having an input section for inputting a job, a post-processor for post-processing of recording mediums formed by the image forming device, the post-processor having a heating section and a first temperature detection section for detecting a temperature of the heating section, and a control section that determines whether a job inputted via the input section can be executed or not, based on first temperature-related information related to a temperature of the heating section detected by the first temperature detection section and a content of the job.

In another aspect of the invention, there is provided an image forming system including an image forming device having an input section for inputting a job, a post-processor for post-processing of recording mediums formed by the image forming device, the post-processor having a heating section and a first temperature detection section for detecting a temperature of the heating section, and a control section that decides a job that can be executed, based on first temperature-related information related to a temperature of the heating section detected by the first temperature detection section.

In still another aspect of the invention, there is provided an image forming device which can be connected with a post-processor for post-processing of recording mediums. This image forming device includes an input section for inputting a job and a control section for determining whether a job inputted via the input section can be executed or not, based on first temperature related information related to a temperature of a heating section provided in the post-processor and a content of the job.

In yet another aspect of the invention there is provided another image forming device which can be connected with a post-processor for post-processing of recording mediums. This image forming device includes an input section for inputting a job and a control section for deciding a job inputted via the input section that can be executed, based on first temperature related information related to a temperature of a heating section provided in the post-processor and a content of the job.

### BRIEF DESCRIPTION OF THE DRAWINGS

FIG. 1 is a conceptual diagram showing an image forming system, wherein a post-processor B is connected to an image forming device A;

FIG. 2 is a diagram showing schematically a bookbinding unit of the post-processor B;

FIG. 3 is a block diagram showing control relationship between the image forming device A and the bookbinding device B;

FIG. 4 is a flow chart showing the flow of control of warm-up and execution of a job in the image forming system in a first embodiment of the invention;

FIG. 5 is a flow chart showing the flow of control of warm-up and execution of a job in an image forming system in a modified example of the first embodiment of the invention;

FIG. 6 is a flowchart showing the first half of the flow of control of warm-up and execution of a job in an image forming system in a second embodiment of the invention; and

FIG. 7 is a flowchart showing the second half of the flow of control of warn-up and execution of a job in the image forming system in the second embodiment of the invention.

### PREFERRED EMBODIMENTS OF THE INVENTION

A first embodiment and second embodiment of the invention will be described below.

### First Embodiment of the Invention

An image forming system in the present embodiment includes an image forming device having an input section for inputting a job, a post-processor for post-processing of recording mediums on which an image has been formed by the image forming device, the post-processor having a heating section and a first temperature detection section for detecting a temperature of the heating section, and a control section that determines whether a job inputted via the input section can be executed or not, based on first temperature-related information related to a temperature of the heating section detected by the first temperature detection section and a content of the job. Further, an image forming system in the present embodiment may have a control section that decides jobs that can be executed, based on the first temperature related information related to the temperature of the heating section.

Still further, an image forming system in the present embodiment may have a fixing section for fixing an image on a recording medium by heat and a second temperature detection section for detecting the temperature of the fixing section, wherein the control section determines whether the job can be executed or not, based on a second temperature related information related to the temperature of the fixing section detected by the second temperature detection section and based on a content of the inputted job.

In an image forming system in the present embodiment, a control unit C1 of the image forming device is the above described control section of which details will be described later.

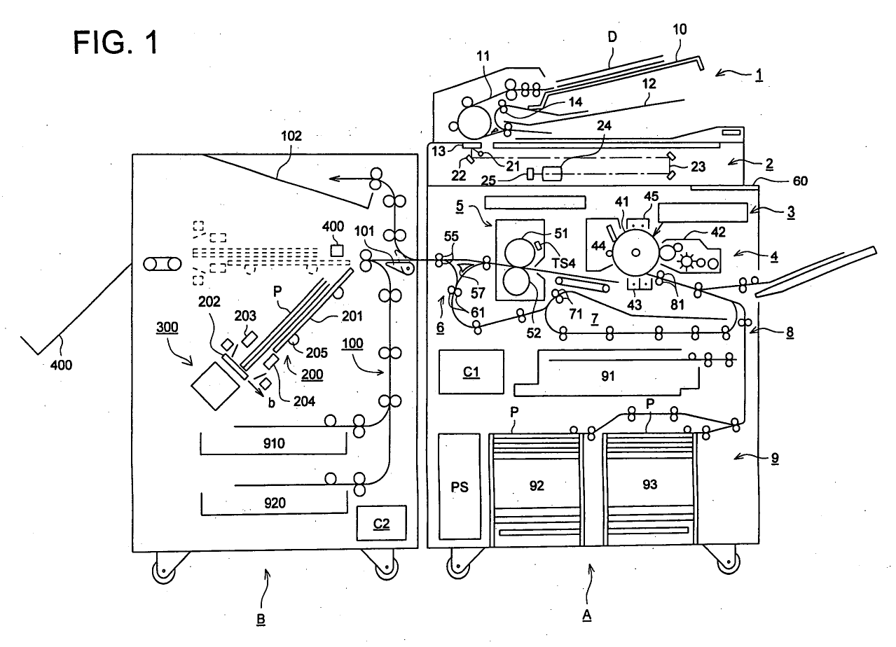

FIG. 1 is a conceptual diagram showing an image forming system wherein an image forming device A is connected with a post-processor B. Image forming device A is a digital type copying machine that forms an image through the known electrophotographic technology, and includes an automatic document feeding device 1, reading unit 2, writing unit 3, image forming unit 4, fixing unit 5, reversing and ejecting unit 6, sheet re-supply unit 7, sheet conveyance unit 8, sheet supply unit 9, control unit C1 and operation-display unit 60. Further, the image forming device A includes FAX transmitting/receiving section 10, not shown, which allows transmitting and receiving via facsimile (hereinafter, referred to as FAX) by connecting with communication lines.

The automatic document feeding device 1 feeds out documents D placed on a document table 10 to document conveyance path 11 one by one, and ejects them onto document ejection table 12. An image surface of document D under conveyance is read by a reading unit 2 at a document reading position 13. When reading images on both sides of document D, document D whose first surface has been read is reversed by a reversing unit 14 to be fed out again to document conveyance path 11, then the second surface thereof is read and the document D is ejected to document ejection table 12. The reading unit 2 includes a light source 21, a first mirror unit 22, a second mirror unit 23, image forming lens 24, CCD 25, and the like, and it scans an image on document D that is running through image reading position 13 to form the image on CCD25, and converts document image information representing optical information into electrical information. The document image information thus converted is subjected to processes such as A/D conversion, shading correction and compression, and is stored in memory M1 of the control unit C1. The writing unit 3 is a scanning optical system including a laser light source, a cylindrical lens, Fθ lens, a mirror, a polygon mirror, and the like, and it scans a surface of a photoconductor 41 of the image forming unit 4 with a laser beam that changes corresponding to image information read out from the memory M1, and forms a latent image on the surface of the photoconductor 41. The image forming unit 4 conducts photographic processing on the latent image formed on the surface of the photoconductor 41 with a developing unit 42, to visualize the latent image as a toner image. The toner image is transferred, by a transfer unit 43, onto a sheet P that is a recording medium fed out by registration roller 81. The photoconductor surface from which the toner image has been transferred is cleaned by a cleaning unit 44 so that residual toner is removed, and is given electric charges by a charging unit 45, to be ready for the subsequent forming of a latent image. The fixing unit 5 fixes the toner image on the sheet P by heating and pressing the sheet P carrying the toner image with a heat roller 51 and pressure roller 52, the rollers 51 and 52 arranged to face each other. The heat roller 51 is heated by a heater, not shown, and a temperature of the heat roller 51 is detected by a temperature detecting unit TS4. Control of heating or keeping warm for the heat roller 51 is made by a control unit, based on information of results of the detection by the temperature detecting unit TS4. The heat roller 51 is the fixing section described above, the temperature detecting unit TS4 is the second temperature detecting section described above, and information of results of the detection by the temperature detecting unit TS4 is the second temperature related information described above.

The sheet P on which the image fixing has been finished is conveyed to the post-processor B by the sheet ejection rollers 55. To reverse and eject the sheet P, the sheet P is guided downward by the sheet ejection guide 57, and the trailing edge of the sheet P is nipped by reversing rollers 61 of a reversing unit, thus, the sheet P is reversed and fed out to the sheet ejection rollers 55. When forming images on both sides of a sheet P, the sheet P is fed, by the sheet ejection guide 57 and a plurality of rollers, to a sheet re-supply unit 7 where the sheet P is reversed by reversing rollers 71 of the sheet re-supply unit 7 to be fed out again to the sheet conveyance unit 8. The sheet conveyance unit 8 conveys the sheet P fed out of sheet supply unit 9, on the conveyance path structured by plural rollers and a guide member, hits the leading edge of the sheet P against a registration roller 81, and further feeds out the sheet P toward photoconductor 41 to receive a toner image thereon after its leading edge hits. The sheet supply unit 9 includes a first sheet supply unit 91 having a small capacity tray, a second sheet supply unit 92 having a large capacity tray and a third sheet supply unit 93. Each sheet feeding unit has a feed out roller to feed out a sheet P placed on each tray to the sheet conveyance unit 8 one sheet by one sheet.

The operation display unit 60 is a touch panel provided off the top of the main body of image forming device A, and it has functions of both display and input, and is used for conducting instructing operations to control unit C1 such as setting copy quantity, setting whether to perform post-processing including bookbinding, setting of FAX transmission, and the like.

The post-processor B has bookbinding unit 300, a hole-making unit 400, and sheet loaders 910 and 920. The post-processor B can perform bookbinding and hole-making for sheets ejected from the image forming device A or sheets mounted on the sheet loaders 910 and 920. The bookbinding and hole-making operations can be so-called online operation, which is performed associated with image forming by the image forming device A, and can be so-called off-line operation, which is performed for sheets mounted on the sheet tables without being associated with image forming by the image forming device A.

When a mode to conduct no post-processing is selected via the operation display unit 60, sheets P that have thereon images formed by image forming device A and are fed out to post-processor B is guided by distributing guide 101 to advance upward and are ejected to a sheet ejection table 102.

When a mode to conduct hole-making is selected, the hole-making unit 400 makes a hole through the sheets, and the sheets are sent out to the sheet loader 400.

When a mode to conduct bookbinding is selected, sheets P which are sent to a sheet adjusting unit 200 sequentially and are stacked in a quantity forming one copy of a book. Further, it is also possible to place a cover or a sheet to be inserted between pages on the sheet loaders 910 and 920, and thereby, to feed out the sheet to the sheet adjusting unit 200 with the conveyance unit 100, so that the sheet placed can be in the position of a predetermined page. The sheet adjusting unit 200 includes a sheet placing table 201, tip-regulating plate 202, sheet pressing members 203 and 204, sheet width regulating plate (not shown), and the like. A tip portion of each of sheets P stacked on the sheet placing table 201 is regulated by tip-regulating plate 202, both sides thereof are regulated by a sheet width regulating plate, thus, the sheets P become an adjusted bundle of sheets. When placing of the sheet of the last page is finished, sheet pressing members 203 and 204 press the tip portion of the stacked bundle of sheets from the top surface and the bottom surface to sandwich them so that the arrangement of the stacked bundle of sheets thus trued up cannot be broken. When the sheet pressing members 203 and 204 finish sandwiching, the tip-regulating plate 202 moves in the direction of arrow b, and a leading end surface of the bundle of sheets faces bookbinding unit 300 with a binding tape TT between them. These operations are controlled by a control unit C2.

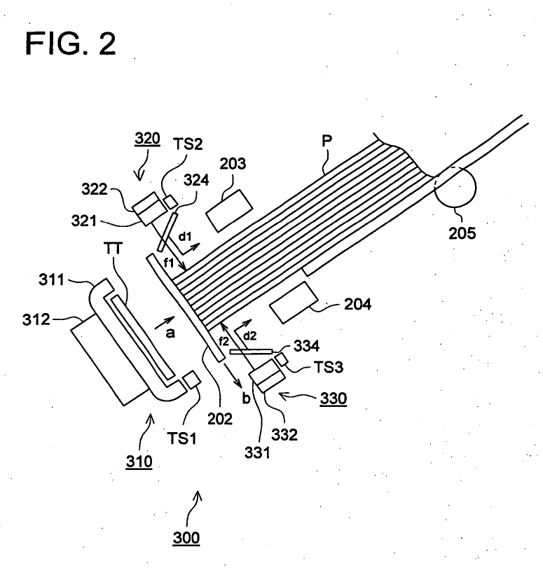

FIG. 2 is a diagram schematically showing the vicinity of the bookbinding unit 300. TT, shown in FIG. 2, is a binding tape coated with a hot-melt type adhesive. The bookbinding unit 300 includes a tape feeder (not shown) that cuts the binding tape TT into a predetermined length and feeds out the tape from a tape winding portion (not shown) to the main heating unit 310. The bookbinding unit 300 presses the tape TT against the back face and side face of the sheet bundle, while heating the tape, and thus binds the sheet bundle into a book. The bookbinding unit 300 includes the main heating unit 310, as heating means, that presses the binding tape TT from the back face side against the front edge face of the adjusted sheet bundle while heating the tape, and a side face heating unit (b) 320 and side face heating unit (c) 330 that presses the both side faces of the binding tape TT against the top face and the bottom face of the sheet bundle while heating the tape.

The main heating unit 310 includes a heating member (a) 311, a heater (a) 312 for heating the heating member (a) 311, and a temperature detecting unit (a) TS1 for detecting the temperature of the heating member (a) 311. The control unit C2 controls power supply to the heater (a) 312 under instruction by the control unit C1, according to the detection result by the temperature detecting unit (a) TS1, and performs control to maintain the temperature of the heating member (a) 311 for a predetermined temperature.

Likewise, the side face heating unit (b) 320 includes a heating member (b) 321, a heater (b) 322 for heating the heating member (b) 321, and a temperature detecting unit (b) TS2 for detecting the temperature of the heating member (b) 321. The control unit C2 controls power supply to the heater (b) 322 under instruction by the control unit C1, according to the detection result by the temperature detection unit (b) TS2, and performs control to maintain the temperature of the heating member (b) 321 for a predetermined temperature.

Likewise, the side face heating unit (c) 330 includes a heating member (c) 331, a heater (c) 332 for heating the heating member (c) 331, and a temperature detecting unit (c) TS3 for detecting the temperature of the heating member (c) 331. The control unit C2 controls power supply to the heater (c) 332 under instruction by the control unit C1, according to the detection result by the temperature detecting unit (c) TS3, and performs control to maintain the temperature of the heating member (c) 331 for a predetermined temperature.

The heating members (a) 311, (b) 321, (c) 331 construct the above described heating section. The temperature detecting units (a) TS1, (b) TS2, and (C) TS3 construct the above described first temperature detecting section, wherein temperature information detected by the temperature detecting unit (a) TS1, the temperature detecting unit (b) TS2, and the temperature detecting unit (C) TS3 is the first temperature related information.

The main heating unit 310 of the bookbinding unit 300 is moved in the direction of arrow a by a heating unit moving unit (not shown) to press binding tape TT against the leading end surface of the bundle of sheets. Owing to this operation, adhesive on the binding tape TT is melted and moves to the leading end surface of the bundle of sheets. Binding tape side guides 324 and 334 move respectively in the directions of arrows d1 and d2 to bend both side surfaces of the binding tape TT toward respectively the uppermost surface and the lowermost surface of the bundle of sheets. After the movement of the binding tape side guides 324 and 334 is finished, the side face heating unit (b) 320 and the side face heating unit (c) 330 move respectively in the directions of arrow f1 and arrow f2 to press the both sides of the binding tape TT thus bent against the uppermost surface and the lowermost surface of the bundle of sheets while heating. Owing to this heating, adhesives on the binding tape TT are melted and move to the both side surfaces of the bundle of sheets. After the pressing time having been set in advance has passed, the main heating unit 310, the side face heating unit (b) 320 and the side face heating unit (c) 330 return to their original positions, and leave the binding tape TT. Thus, the adhesive melted on the binding tape TT is hardened by its rapid fall of temperature, and the hardened adhesive fixes the binding tape TT and the sheet bundle, and thus bookbinding is performed.

Sheet adjusting unit 200 moves to a position shown with dotted lines in FIG. 1, while keeping its state wherein a tip portion of the bound bundle of sheets is held by sheet pressing members 203 and 204. After that, pressing by the sheet pressing members 203 and 204 is released, and the bundle of sheets is sent out to a tray for bundle of sheets 400 by rotating a roller 205 provided on the sheet placing table 201.

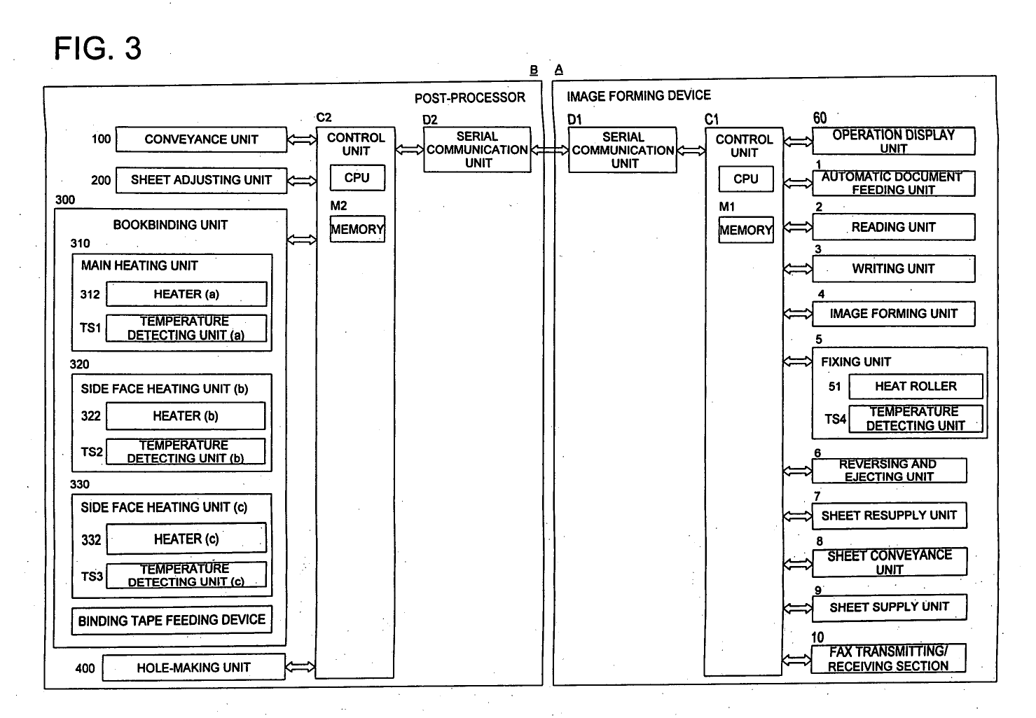

FIG. 3 is a block diagram showing controlling relationship between the image forming device A and the post-processor B in the image forming system in the present embodiment. Incidentally, in the descriptions of the present diagram, those for the portions which are not related directly to the present embodiment are omitted.

The control unit C1 of the image forming device A is a computer system configured by a CPU, processing unit, memory M1, input-output I/F, communication device, driving circuit, and the like. The control unit C1 controls operations of the automatic document feeding unit 1, reading unit 2, writing unit 3, image forming unit 4, fixing unit 5 having the heat roller 51 and the temperature detecting unit TS4, reversing and ejecting unit 6; sheet re-supply unit 7, sheet conveyance unit 8, sheet supply unit 9, FAX transmitting/receiving section 10 connected with a communication line via a modem, not shown, and operation display unit 60. The control unit C1 also transmits a control signal including job information related to post-processing inputted via the operation display unit 60, via a serial communication unit D1, to the post-processor B. These controls are performed by execution of a certain program stored in advance in the memory M1. The control unit C1 is the above described control section. The functions of the control section are incorporated in the control unit C1 of the image forming device A for a simple structure.

The control unit C2 of the post-processor is smaller than the control unit C1, but has a similar structure. The control unit C2 receives a control signal transmitted from the connected image forming device A, via the serial communication unit D1, and performs control to carry out post-processing such as bookbinding and hole-making of sheets ejected from the image forming device A or sheets stacked on the sheet loaders 910 and 920, using the conveyance unit 100, sheet adjusting unit 200, bookbinding unit 300, and hole-making unit 400. In performing post-processing on the sheets ejected from the image forming device A, the post-processing is performed as online operation linked with the image forming operation of the image forming device A. In performing post-processing on the sheets stacked on the sheet loaders 910 and 920, the post-processing is performed as offline operation that is independent from the image forming operation of the image forming device A. Further, upon instruction by the control unit C1 of the image forming device A, execution of warm-up of the bookbinding unit 300 and the operation of a job during the warming-up are controlled by executing a program stored in the memory M2. These controls are carried out by execution of a program stored in the memory M2.

The control unit C1 compares temperature information of the heat roller 51 detected by the temperature detecting unit TS4 of the fixing unit 5 of the image forming device A, with a threshold stored in advance in the memory M1. If the temperature is higher than or equal to the threshold, the control unit C1 determines that the temperature of the heat roller 51 has reached a predetermined temperature, namely, warm-up is completed, then the control unit C1 terminates warm-up. If the temperature is lower than the threshold, namely, warm-up is not completed, then the control unit C1 performs control to supply power to the heater of the fixing unit 5 until the temperature of the fixing unit 5 reaches the predetermined temperature.

When the control unit C1 has terminated the warm-up, the control unit C1 controls the power supply to the heater, based on the temperature information detected by the temperature detecting unit TS4, to perform control to maintain the temperature of the heat roller 51 to be in a predetermined temperature range.

Further, the control unit C1 compares temperature information of the respective heating units obtained by the respective temperature detecting unit (a) TS1, temperature detecting unit (b) TS2, temperature detecting unit (c) TS3 of the bookbinding unit 300, the information transmitted from the post-processor B via the serial communication unit D2, with respective thresholds stored in advance in the memory M1. If the respective temperatures are higher than or equal to the respective thresholds, then the control unit C1 determines that the temperatures of the respective heating units have reached predetermined temperatures, namely warm-up is completed, and instructs the control unit C2 to terminate warm-up, thereby terminating warm-up of the heater (a) 312, heater (b) 322, and heater (c) 332. Further, if the temperatures are lower than the respective thresholds, then the control unit C1 determines that the temperatures of the respective heating units of the bookbinding unit 300 have not reached the predetermined temperature, namely, warm-up is not completed, and instructs the control unit C2 to supply power to the heater (a) 312, heater (b) 322, and heater (C) 332 until the temperatures of the respective heating units of the bookbinding unit 300 reach the predetermined temperature, thus continuing the warm-up. When the control unit C1 has terminated the warm-up, the control unit C1 controls the supply power to the respective heaters, based on the temperature information detected by the temperature detecting units TS1, TS2, and TS3, to perform control to maintain the temperatures of the respective heating units to be in a predetermined temperature range.

Although, in the description below, it is assumed that power is not supplied to the fixing unit of the image forming device or the heating units of the post-processor during execution of the energy saving mode, the invention is not limited to this. In the energy saving mode, a power lower than the power supply amount in a mode allowing image forming operation or in a mode performing bookbinding may be supplied to the fixing unit of the image forming device and the heating units of the post-processor.

When the control unit C1 is powered on or the operation of the control unit C1 is started from the energy saving mode, the control unit C1 instructs start of warm-up of the fixing unit 5 of the image forming device A, which is start of power supply to the heater of the fixing unit 5 in the case of the present embodiment, and instructs the control unit C2 of the post-processor B to start warm-up of the bookbinding unit 300, which is start of power supply to the heaters of the respective heating units of the bookbinding unit 300.

When a job is input or there is a job already inputted, the control unit C1 of the image forming device A confirms the state of the temperature of the fixing unit and the temperatures of the heating units. The control unit C1 determines whether the inputted job or the already inputted job requires the fixing unit of the image forming device A or the respective heating units of the bookbinding unit 300 of the post-processor B, and then decides whether to permit execution of the job or not, based on the confirmed result about the state of the temperature of the fixing unit and the temperatures of the heating units. If a decision is made to permit the execution of the job, then the job is executed, and if a decision is made not to permit execution of the job is made, then the job is registered in a queue.

The job registered in the queue is, as a waiting job for execution, confirmed to be executable or not, as warm-up progresses for the fixing unit of the image forming device A and the heating units of the post-processor B, and is executed at the moment it becomes executable.

The control unit C1 determines whether the job can be executed or not, based on the state pf the temperature of the heat roller 51 of the image forming device A and the temperatures of the respective heating members of the bookbinding unit 300 and based on the content of the job. The control unit C1 confirms the state of the temperatures of the heat roller 51 of the image forming device A, the respective heat members of the bookbinding unit 300, namely, the heating member (a) 311, heating member (b) 321, and the heating member (C) 331, and also confirms whether the job uses the fixing section and/or heating sections for execution thereof. Based on the confirmed result, the job is determined to be executable or not.

If the temperature of the heat roller 51 of the image forming device A has not reached the predetermined temperature, in other words, warm-up of the fixing unit of the image forming device A is not completed, a job using the fixing unit of the image forming device A cannot be executed. Therefore, the control unit C1 confirms the content of the job, and if the job is one which uses the fixing unit of the image forming device A, then the control unit C1 prohibits execution of the job, and if the job is one which does not use the fixing unit of the image forming device A, then the control unit C1 permits execution of the job.

A job which is permitted to be executed and does not use the fixing unit of the image forming device A is, for example, in the case of the image forming system in the present embodiment, bookbinding processing on offline basis wherein the temperatures of the bookbinding unit 300 have reached the predetermined temperature, or hole-making processing or transmitting/receiving of FAX on offline basis wherein the temperatures have not reached the predetermined temperature.

If the temperatures of the respective heating members of the bookbinding unit 300 have not reached the predetermined temperature, in other words, warm-up of the bookbinding unit 300 is not completed, a job which uses the heating section of the bookbinding unit 300 cannot be executed. Therefore, the control unit C1 confirms the content of the job, and if the job is one that uses the heating section of the bookbinding unit 300, then the control unit C1 prohibits execution of the job, and if the job is one that does not use the heating section of the bookbinding unit 300, then the control unit C1 permits execution of the job.

A job that is permitted to be executed and does not use the heating section of the bookbinding unit 300 is, for example, in the image forming system in the present embodiment, hole-making processing on online basis or copying wherein the fixing unit of the image forming device A has reached the predetermined temperature, and is hole-making processing on offline basis or transmitting/receiving of FAX wherein the temperature has not reached the predetermined temperature.

Incidentally, if the temperature of the fixing unit of the image forming device A and the temperature of the heating section of the bookbinding unit 300 have reached the predetermined temperatures, a job that uses the fixing unit of the image forming device A and the heating section of the bookbinding unit 300 is permitted to be executed, which means any job is permitted to be executed.

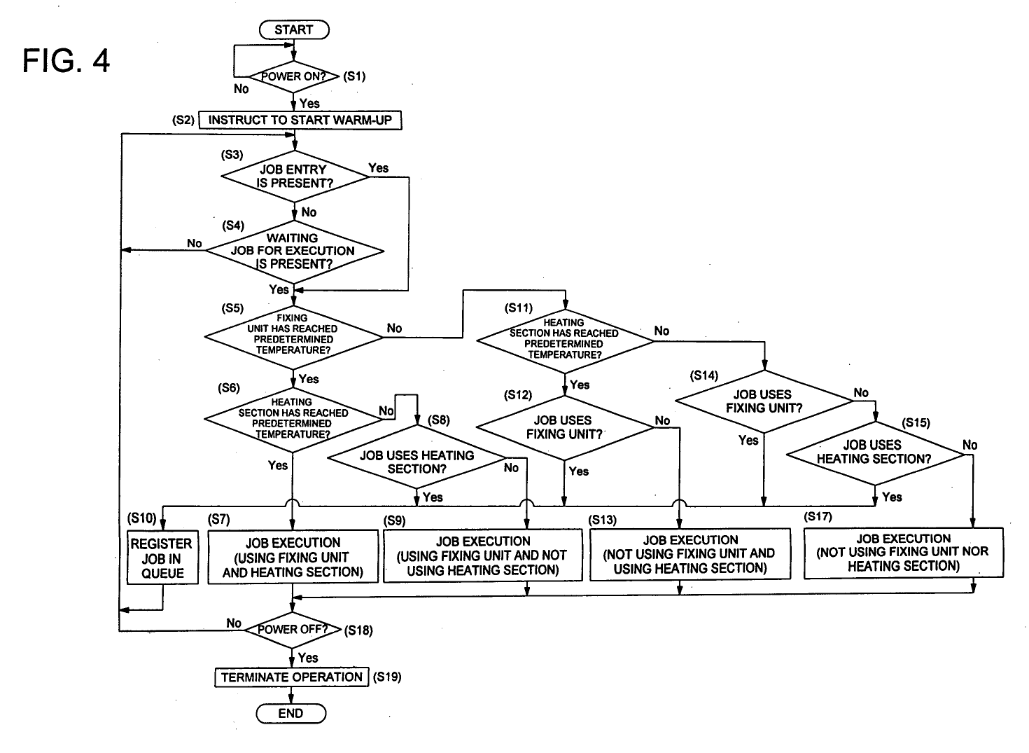

FIG. 4 is a flowchart describing the control flow of warm-up and a job in the image forming system of the first embodiment of the invention.

The control unit C1 waits for powering on the system, and when the system is powered on (step S1), the control unit C1 instructs to start warm-up of the image forming device and the post-processor (step S2). Start of warm-up of the image forming device and the post-processor may be a return from the energy saving mode to the normal operation mode. The return from the normal operation mode to the energy saving mode is carried out, triggered by operation or input of a job via the operation display unit of the image forming device.

Next, the control unit C1 confirms whether entry of a new job is present (step S3). In step S3, if entry of a new job is present (step S3: Yes), the program proceeds to step S5. If entry of a new job is not present (step S3: No), the program proceeds to step S4 to confirm whether a waiting job is present or not, and if a waiting job is present (step S4: Yes), then the program proceeds to step S5. If a waiting job is not present (step S4: No), the program waits for job entry while executing step S3 and step S4. Herein, a waiting job is a job registered in a queue. More details will be described later.

In step S5, the control unit C1 compares the temperature information of the heat roller 51 detected by the temperature detecting unit TS4 with a predetermined value, and thus determines whether the fixing unit 5 has reached the predetermined temperature.

If the information value of the temperature by the temperature detecting unit TS4 has reached the predetermined value (step S5: Yes), then the control unit C1 determines that warm-up of the fixing unit 5 is completed, permits execution of a job which uses the fixing unit 5, and then proceeds to step S6.

If the information value of the temperature by the temperature detecting unit TS4 has not reached the predetermined value (step S5: NO), the control unit C1 determines that warm-up of the fixing unit 5 is not completed, prohibits execution of a job that uses the fixing unit 5, and proceeds to step S11.

If the information value of the temperature by the temperature detecting unit TS4 has reached the predetermined value (step S5: Yes), then the control unit C1 confirms whether the temperatures of the respective heating units of the bookbinding unit 300 of the bookbinding device B, namely, the temperatures of the heating section have reached respective predetermined temperatures (step S6).

If the information values by the temperature detecting unit (a) TS1, the temperature detecting unit (b) TS2, and the temperature detecting unit (c) TS3 have reached the predetermined value (step S6: Yes), then the control unit C1 determines that warm-up of the heating section is completed and permits execution of a job which uses the heating section, and proceeds to step S7. In step S7, jobs including jobs which use the fixing unit 5 and the heating section, in other words, any job is permitted to be executed, and executed. When a job has been executed, the program proceeds to step S18.

If the information by the temperature detecting unit (a) TS1, the temperature detecting unit (b) TS2, and the temperature detecting unit (c) TS3 have not reached the predetermined value (step S6: No), then the control unit C1 determines that warm-up of the bookbinding unit 300 is not yet complete, and prohibits execution of a job that uses the heating units, and proceeds to step S8.

In step S8, the control unit C1 confirms whether or not a job uses the heating section, and if the job does not use the heating section (step S8: No), then the job which uses the fixing unit 5 and does not use the heating section is permitted to be executed, and then the program proceeds to step S9. In step S9, the job which uses the fixing unit 5 and does not use the heating section is executed, and then the program proceeds to step S18.

In step S8, if a job is judged to use the heating section (step S8: Yes), execution of the job is prohibited to be executed because warm-up of the heating section to be use by the job is not yet completed, and the program proceeds to step S10. In step S10, a job which is not permitted to be executed is registered in a queue.

As described above, if the information value by the temperature detecting unit TS4 has not yet reached the predetermined value (step S5: No), a job which uses the fixing unit 5 is prohibited to be executed, and the program proceeds to step S11. In step S11, the control unit C1 confirms whether or not the respective temperatures in the heating section of the bookbinding unit 300 of the post-processor B have reached the predetermined temperature.

In step S11, if the information values by the temperature detecting unit (a) TS1, temperature detecting unit (b) TS2, and temperature detecting unit (c) TS3 have reached the predetermined value (step S11: Yes), the control unit C1 determines that warm-up of the heating section is completed, permits execution of a job which uses the heating section, and proceeds to step S12.

In step S12, the control unit C1 confirms whether or not a job uses the fixing unit, and if the job does not use the fixing unit (step S12: No), the job which uses the heating section and does not use the fixing unit is permitted to be executed, and the program proceeds to step S13. In step S13, the job which uses the heating section and does not use the fixing unit is executed. When the job has been executed, the program proceeds to step S18.

In step S12, if a job is judged to use the fixing unit (step S12: Yes), the job is prohibited to be executed because warm-up used by the job is no yet completed, and the program proceeds to step S10. In step S10, a job which is not permitted to be executed is registered in a queue.

Information values by the temperature detecting unit (a) TS1, the temperature detecting unit (b) TS2, and the temperature detecting unit (c) TS3 have not reached the predetermined value (step S11: No), the control unit C1 determines that warm-up of the bookbinding unit 300 is not yet completed, prohibits execution of a job which uses the heating units, and proceeds to step S14.

In step S14, the control unit C1 confirms whether the job uses the fixing unit, and if the job is judged to use the fixing unit (step S14: Yes), the control unit C1 prohibits execution of the job because warm-up of the fixing unit used by the job is not yet completed, and the program proceeds to step S15.

In step S15, the control unit C1 confirms whether the job uses the heating section, and if the job is judged to use the heating section (step S15: Yes), the control unit C1. prohibits execution of the job because warm-up of the heating section used by the job is not yet completed, and the job which is not permitted to be executed is registered in a queue. If the job does not use the heating section (step S15: No), execution of the job is permitted because the job uses neither the fixing unit nor the heating section, and the program proceeds to step S17. In step S17, a job which uses neither the heating section nor the fixing unit is executed. When the job has been executed, the program proceeds to step S18.

A job registered in a queue in step S10 returns to step S3, and as a waiting job for execution, when the temperature of the fixing unit and/or the heating section reaches a temperatures at which job execution can be permitted, the job is executed. The job executed here is deleted from the queue.

The control unit C1 has executed a job in step S7, S9, S13, or S15, proceeds to step S18, and confirms whether power supply to the system has been turned off. If the power supply to the system has not been turned off (step S18: NO), the control unit C1 proceeds to step S3 and waits for entry of a new job. If the power supply has been turned off (step S18: Yes), the control unit C1 proceeds to step S19, and terminates the operation of the image forming system.

As described above, in accordance with the present embodiment, if the temperature of the fixing unit of the image forming device constructing the image forming system has reached a predetermined temperature, in other words, warm-up of the image forming device has been completed, even in a case where the temperatures of the respective heating units of the post-processor constructing the image forming system have not reached a predetermined temperature, in other words, even in a case where warm-up of the bookbinding unit is not yet completed, a job which does not use the bookbinding device is permitted to be received. Accordingly, a waiting time imposed on the user can be shortened, and a useful bookbinding system can be provided.

### Example Modified from the First Embodiment of the Invention

The image forming system in the first embodiment determines whether or not a job can be executed, based on the second temperature related information related to the temperature of a fixing section of the image forming device, in addition to the first temperature related information, and based on the content of a job. As a modified example, it is possible to prohibit execution of any job, based on the second temperature related information related to the temperature of the fixing section of the image forming device, in a case where the temperature of the fixing section has not reached a predetermined temperature. In the modified example, if the fixing section of the image forming device has not reached the predetermined temperature, any job is prohibited to be executed. Accordingly, fixing operation can be prevented in a state where the temperature of the fixing section has not reached a required temperature which allows the fixing section to fix an image on a recording medium. When the temperature of the fixing section has reached the predetermined temperature, an executable job is permitted to be executed, based on the temperature of the heating section of the post-processor.

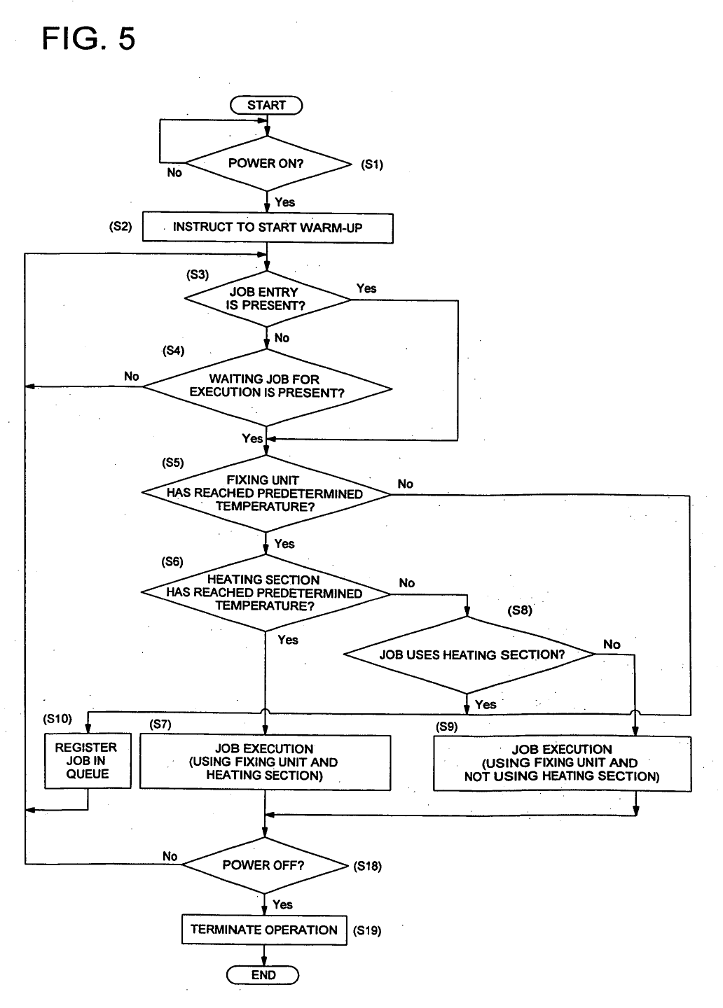

FIG. 5 is a flow chart describing the flow of control of warm-up and execution of a job in the image forming system in a modified example from the first embodiment of the invention. In FIG. 5, steps S11 to S17 are deleted from the flowchart in the first embodiment, shown in FIG. 4, wherein in a case that the information value by the temperature detecting unit TS4 has not reached the predetermined value (step S5: No), the program proceeds to step S10. The modified example from the first embodiment will be described below, referring to the flowchart shown in FIG. 5.

The control unit C1 waits for power on the system and when power is turned on the system (step S1), the control unit C1 instructs to start warm-up of the image forming device and the post-processor (step S2). Incidentally, the start of warm-up of the image forming device and the post-processor may be a return from the energy saving mode to the normal operation mode. A return from the normal operation mode to the energy saving mode is triggered by operation via the operation display unit of the image forming device, an input of a job, or the like.

Next, the control unit C1 confirms whether entry of a new job is present or not (step S3). In step S3, if entry of a new job is present (step S3: Yes), the program proceeds to step S5. In step S3, if entry of a new job is not present (step S3: No), the control unit C1 proceeds to step S4, confirms whether a waiting job for execution is present or not, and if a waiting job for execution is present (step S4: Yes), the control unit C1 proceeds to step S5. If a waiting job for execution is not present (step S4: NO), the control unit C1 waits for entry of a job through executing the processes in step S3 and in step S4.

In step S5, the control unit C1 compares the temperature information of the heat roller 51 detected by the temperature detecting unit TS4 with the predetermined value, and confirms whether the temperature by the information has reached the predetermined temperature, namely, whether the temperature of the fixing unit 5 has reached the predetermined temperature.

If the information value of the temperature by the temperature detecting unit TS4 has reached the predetermined value (step S5: Yes), the control unit C1 determines that warm-up of the fixing unit 5 is completed, permits execution of a job which uses the fixing unit 5, and proceeds to step S6.

If the information value by the temperature detecting unit TS4 has not reached the predetermined temperature (step S5: No), the control unit C1 determines that warm-up of the fixing unit 5 is not yet completed, prohibits execution of any job, and proceeds to step S10. In step S10, a job which is not permitted to be executed is registered in a queue.

If the information value by the temperature detecting unit TS4 has reached the predetermined value (step S5: Yes), the control unit C1 confirms whether the temperatures of the respective heating units of the bookbinding unit 300 of the post-processor B, namely, temperatures in the heating section, have reached the predetermined temperature (step S6).

If the information values by the temperature detecting unit (a) TS1, temperature detecting unit (b) TS2, temperature detecting unit (c) TS3 have reached the predetermined value (step S6: Yes), the control unit C1 determines that warm-up of the heating section is completed, permits execution of a job which uses the heating section, and proceeds to step S7. In step S7, a job including a job which uses the fixing unit 5 and the heating section, in other words, any job is permitted to be executed and executed. When a job has been executed, the program proceeds to step S18.

If information values by the temperature detecting unit (a) TS1, the temperature detecting unit (b) TS2, and the temperature detecting unit (c) TS3 have not reached the predetermined value (step S6: No), the control unit C1 determines that warm-up of the bookbinding unit 300 is not yet completed, prohibits execution of a job which uses the heating units, and proceeds to step S8.

In step S8, the control unit C1 confirms whether or not a job uses the heating section, and if the job does not use the heating section (step S8: No), the control unit C1 permits the job to be executed which uses the fixing unit 5 and does not use the heating section, and proceeds to step S9. When the job has been executed, the program proceeds to step S18.

In step S8, if a job uses the heating section (step S8: Yes), the control unit C1 prohibits execution of the job which uses the heating section of which warm-up is not yet completed, and proceeds to step 10. In step S10, the job which is not permitted to be executed is registered in a queue.

The job registered in the queue returns to step S3, and as a waiting job for execution, the job is executed when the fixing unit and/or the heating section has reached a temperature at which the job is permitted to be executed. The job executed then is deleted from the queue.

When a job is executed in step S7 or S9, the control unit C1 proceeds to step S18, and confirms whether or not the power of the system has been turned off. If the power OFF has not been carried out (step S18: NO), the program control unit C1 returns to step S3 and waits for entry of a new job. If the power OFF is carried our (step S18: Yes), the control unit C1 proceeds to step S19, and terminates the operation of the image forming system.

### Second Embodiment of the Invention

A second embodiment has a structure common with the descriptions with reference to FIGS. 1 to 3 in the above described first embodiment, and those functions also have much in common. In the second embodiment, elements having the same functions as those in the first embodiment are given with the same symbols as used in the first embodiment, and different points from the first embodiment will be described, omitting the descriptions of the same.

A control device C1 in the second embodiment decides executable jobs, based on the temperature state of a heat roller 51 of an image forming device A and the temperature state of heating members of a bookbinding unit 300 detected by a temperature detecting unit (a) TS1, temperature detecting unit (b) TS2, and temperature detecting unit (c) TS3. The control device C1 confirms the content of an inputted job or a job having been already inputted, and determines whether it can be executed. If the job is executable, then the control unit C1 permits execution of the job, and if the job is not executable then the control device C1 prohibits execution and registers the job in a queue. The job registered in the queue is, as a waiting job for execution and as warm-up of the fixing unit of an image forming device A and heating units of a post-processor B proceeds, permitted to be executed at the time when it becomes executable. Further, the control unit C1 performs control to display executable jobs, on an operation display unit 60, decided base on the temperature state of the heat roller 51 of the image forming device A and the temperature state of the heating members of the bookbinding unit 300.

In the second embodiment, in order to indicate whether warm-up is completed or not completed, the heat roller 51 of the image forming device A is provided with a fixing unit temperature flag, and the respective heating members of the bookbinding unit 300 of the post-processor B are provided with a heating section temperature flag, which respectively distinguish warm-up completion state by ON and warm-up incompletion state by OFF. The control unit C1 terminated warm-up when the temperatures of all the heating units of the bookbinding unit 300 have come to a predetermined values, or when the temperatures have already reached the predetermined value, and makes the state of the heating section flag ON. Further, the control unit C1 terminates warm-up when the temperature of the heat roller 51 has come to a predetermined value or when the temperature has already reached the predetermined value, and makes the state of the fixing unit temperature flag ON.

Executable jobs depending on the temperature state of the heat roller 51 of the image forming device A and the bookbinding unit 300 are as follows.

That is, when neither the image forming device A nor the bookbinding unit 300 has completed warm-up, jobs which use the fixing unit of the image forming device A or the respective heating members of the bookbinding unit 300 cannot be executed. However, jobs which do not use the fixing unit of the image forming device A or the respective heating members of the bookbinding unit 300, for example, in an image forming system in the present embodiment, FAX transmitting/receiving and hole-making processing on offline basis can be executed. A mode for such jobs which use neither the fixing unit of the image forming device A nor the respective heating members of the bookbinding unit 300 is referred to as mode D. The control unit C1 decides that the mode for executable jobs is mode D when neither the temperature of the heat roller 51 of the image forming device A nor the temperatures of the respective heating members of the bookbinding unit 300 has reached the respective predetermined temperatures. Herein, the control unit C1 also controls to display that the mode of executable jobs is mode D on an operation display unit 60, for example, with a message “The system is in warm-up. Jobs can be input. Fax transmission and hole-making processing on offline basis are possible. Execution of other jobs needs to wait for a while.”

When the heat roller 51 of the image forming device A has not reached the predetermined temperature and the respective temperatures of the respective heating members of the bookbinding unit 300 have reached the predetermined temperature, in other words, warm-up of the image forming device A is not yet completed and warm-up of the bookbinding unit 300 is completed, jobs that uses the fixing unit of the image forming device A cannot be executed, but jobs that do not use the fixing unit of the image forming device A, for example, in the image forming system in the present embodiment, FAX transmitting/receiving, hole-making processing, and bookbinding processing on offline basis are possible. The mode for such jobs that do not use the fixing unit of the image forming device A is referred to as node C. In mode C, for example, FAX transmitting/receiving, hole-making processing, and bookbinding processing are possible. The control unit C1 decides the mode for executable jobs to be mode C, when the heat roller 51 of the image forming device A has not reached the predetermined temperatures and the temperatures of the respective heating members of the bookbinding unit 300 have reached the predetermined temperature. Herein, the control unit C1 performs control to display that the mode for executable jobs is mode C on the operation display unit 60, for example, with a message “The system in warm-up. Jobs can be input. FAX transmission, bookbinding processing, hole-making processing on offline basis are possible. Other jobs need to wait for a while.” If there is a job having been input, the control unit C1 determines whether the job is executable or not in mode C, and if executable, permits execution of the job, and the job is executed.

If the heat roller 51 of the image forming device A has reached the predetermined temperature and the temperatures of the respective heating members of the bookbinding unit 300 have not yet reached the respective predetermined temperatures, in other words, warm-up of the image forming device A is completed and warm-up of the respective heating members of the bookbinding unit 300 are not yet completed, jobs which use the respective heating members of the bookbinding unit 300 cannot be executed, and jobs which do not use the respective heating members of the bookbinding unit 300, for example, FAX transmitting/receiving, copying, hole-making on offline basis are possible. The mode for such jobs which do not use the respective heating members of the bookbinding unit 300 is referred to as mode B. In mode B, the control unit C1 decides the mode for executable jobs to be mode B, when the heat roller 61 of the image forming device A has reached the predetermined temperature and the temperatures of the respective heating members of the bookbinding unit 300 have not reached the respective predetermined temperature, and performs control to display that the mode for executable job is mode B, for example, with a message “Copying is possible. The post-processor is in warm-up. A job requiring bookbinding is to wait for a while.” If there is a job having been input, the control unit C1 determines whether or not the job can be executed in mode B and if executable, the job is executed.

If the temperature of the heat roller 51 of the image forming device A and the temperatures of the respective heating members of the bookbinding unit 300 have reached the respective predetermined temperatures, that is, warm-up of the image forming device A and warm-up of the bookbinding unit 300 are both completed, any job can be executed. Mode for such jobs is referred to as mode A. If the temperature of the heat roller 51 of the image forming device A and the temperatures of the respective heating members of the bookbinding unit 300 have reached the respective predetermined temperatures, the control unit C1 decides the mode for executable jobs to be mode A, and performs control to display that the mode for executable jobs is mode A on the operation display unit 60, for example, with a message “Copying and using the post-processor are possible.” If there is a job having been input, the control unit C1 permits execution of the job, and the job is executed.

There is shown in Table 1 the modes for executable jobs in combination of temperature states of the heat roller 51 of the image forming device A and the respective heating members of the bookbinding unit 300 of the post-processor B.

TABLE 1

| | Post-processor Heating | |
|---|---|---|
| | has not yet reached | has already reached |
| section Image | predetermined | predetermined |
| forming device | temperature | temperature |
| Fixing section | (warm-up incomplete) | (warm-up complete) |
| has not yet reached | Mode D | Mode C |
| predetermined | | |
| temperature | | |
| (warm-up incomplete) | | |
| has already reached | Mode B | Mode A |
| predetermined | | |
| temperature | | |
| (warm-up complete) | | |

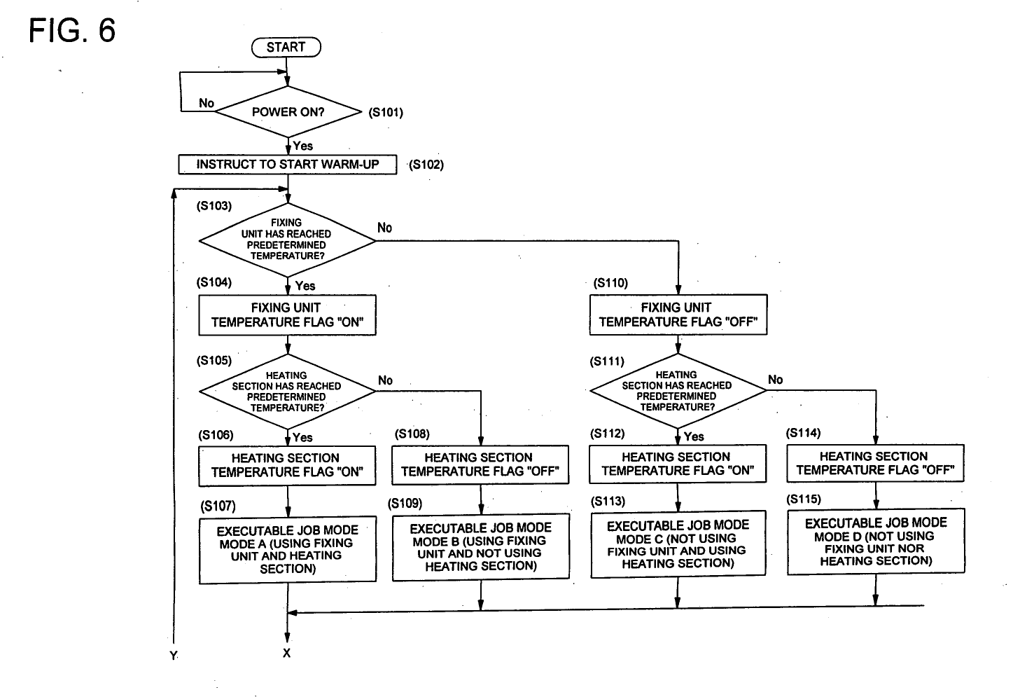

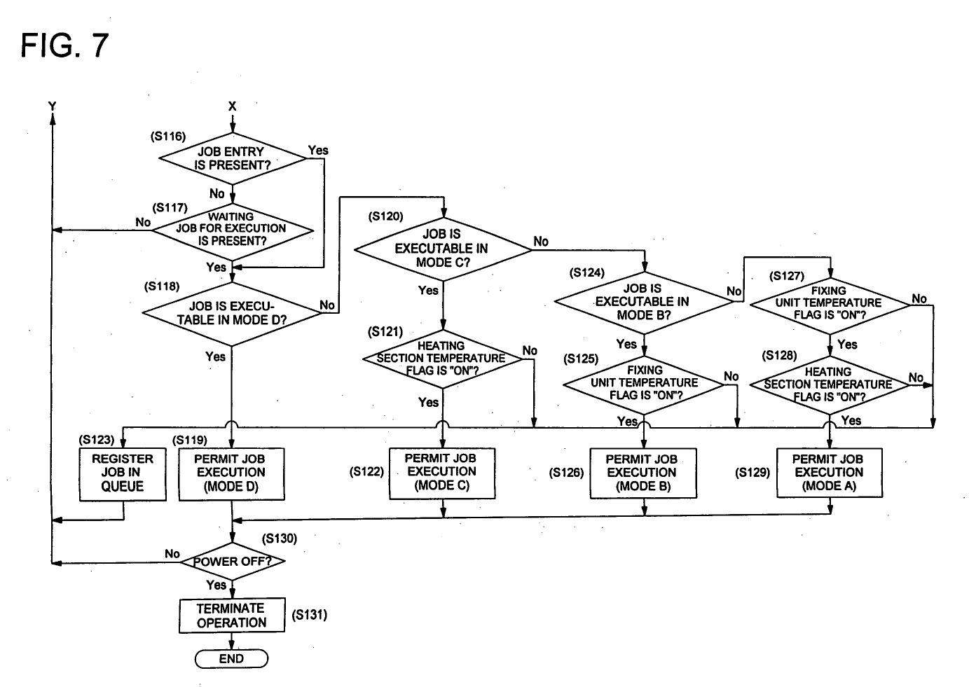

FIGS. 6 and 7 are flowcharts showing the flow of control of warm-up of the image forming system and job execution in the second embodiment of the invention. FIG. 6 is a flowchart showing the first half of the flow of control of warm-up and job execution. FIG. 7 is a flowchart showing the second half of the flow of control. Combination of FIG. 6 and FIG. 7 with joint at the two positions X and Y makes the entire flow of control of warm-up of the image forming system and job execution in the second embodiment of the invention. The flow will be described below, referring to FIGS. 6 and 7.

First, the control unit C1 waits for turning on power to the system in step S101, shown in FIG. 6. When power is turned on the system (step S101: Yes), the control unit C1 performs control to start warm-up of the image forming device and the post-processor (step S102). Incidentally, warm-up start may be a return from the energy saving mode to the normal operation mode. Return from the energy saving mode to the normal operation mode is triggered by operation via the operation display unit of the image forming device, job input, or the like.

Next, the control unit C1 compares temperature information of the heat roller 51 detected by a temperature detecting unit TS4, and confirms whether the temperature has reached the predetermined temperature or not, in other words, the fixing unit has reached the predetermined temperature or not (step S103).

If the information value of the temperature of the temperature detecting unit TS4 exceeds the predetermined values, in other words, if the fixing unit 5 has reached the predetermined temperature (step S103: Yes), the control unit C1 determines that warm-up of the fixing unit 5 is completed, and terminates warm-up of the fixing unit 5 and makes the fixing unit temperature flag ON state (step S104). If the information of the temperature detecting unit TS4 is not exceeding the predetermined value (step S103: No), the control unit C1 determines that warm-up of the fixing unit 5 is not yet completed, continues warm-up of the fixing unit 5, and proceeds to step S110.

Next, based on information from the temperature detecting unit (a) TS1, the temperature detecting unit (b) TS2, and the temperature detecting unit (c) TS3 which detect the temperatures of the respective heating units of the bookbinding unit 300 of the post-processor B, the control unit C1 confirms whether the temperatures of the respective heating units have reached the predetermined temperature, in other words, whether or not the heating section has reached the predetermined temperature (step S105).

If the information by the temperature detecting unit (a) TS1, the temperature detecting unit (b) TS2, and the temperature detecting unit (c) TS3 exceeds the predetermined value, in other words, the heating section has reached the predetermined temperature (step S105: Yes), the control unit C1 determines that warm-up of the bookbinding unit 300 is completed, terminates warm-up of the respective heating units, makes the heating section temperature flag ON state (step S106), decides the mode of executable jobs to be mode A, and performs control to display on the operation display unit 60 that the mode of executable jobs is mode A, for example, with a message “Copying and using of the post-processor are possible” (step S107). If the information by the temperature detecting unit (a) TS1, the temperature detecting unit (b) TS2, and the temperature detecting unit (c) TS3 does not exceed the predetermined value (step S105: No), the control unit C1 determines that warm-up of the bookbinding unit 300 is not yet completed, continues warm-up of the respective heating units, makes the heating section temperature flag OFF state (step S108), decides the job for executable jobs to be mode B and performs control to display on the operation display unit 60 that the mode for executable jobs is mode B, for example, with a message “Copying is possible. The post-processor is in warm-up. A job requiring bookbinding is to wait for a while” (step S109).

In step S103, if the information by the temperature detecting unit TS4 is not exceeding the predetermined value (step S103: No), the control unit C1 determines that warm-up of the fixing unit 5 is not yet completed, continues warm-up of the fixing unit 5, proceeds to step S110, and makes the fixing unit temperature flag OFF state.

Then, based on information by the temperature detecting unit (a) TS1, the temperature detecting unit (b) TS2, and the temperature detecting unit (c) TS3 which detect the temperatures of the respective heating units of the bookbinding unit 300 of the post-processor B, the control unit C1 confirms whether the respective temperatures of the respective heating units have reached the predetermined temperature, in other words, whether the heating section has reached the predetermined temperature (step S111).

If the information by the temperature detecting unit (a) TS1, the temperature detecting unit (b) TS2, and the temperature detecting unit (c) TS3 is exceeding the predetermined value, in other words, the heating section has reached the predetermined temperature (step S111: Yes), the control unit C1 determines that warm-up of the bookbinding unit 300 is completed, terminates warm-up of the respective heating units, makes the heating section temperature flag ON state (step S112), decides the mode for executable jobs to be mode C, and performs control to display on the operation display unit 60 that the mode for executable jobs is mode C, for example, with a message “The system is in warm-up. Jobs can be input. FAX transmission, and bookbinding processing and hole-making processing on offline basis are possible” (step S113). If the information by the temperature detecting unit (a) TS1, the temperature detecting unit (b) TS2, and the temperature detecting unit (c) TS3 is not exceeding the predetermined value (step S111: No), the control unit C1 determines that warm-up of the bookbinding unit 300 is not yet completed, continues warm-up of the respective heating units, makes the heating section temperature flag in OFF state (step S114), decides the mode for executable jobs to be mode D, and performs control to display on the operation display unit 60 that the mode for executable jobs is mode D, for example, with a message “The system is in warm-up. Jobs can be input. FAX transmission and hole-making processing on offline basis is possible. Other jobs are to wait for a while” (step S115).

After making a decision of the mode for executable jobs by confirmation of the fixing unit and the heating section and display of executable jobs in steps S103 to S115, the control unit C1 proceeds to step S116, shown in FIG. 7, via “X”.

In step S116, shown in FIG. 7, the control unit C1 confirms whether there is a job entry.

If there is a job entry (step S116: Yes), the control unit proceeds to step S118, and if there is no job entry (step S116: No), the control unit C1 proceeds to step S117 to confirm whether there is a waiting job for execution, and if there is a waiting job for execution (step S117: Yes), the control unit C1 proceeds to step S118. Herein, the waiting job for execution is a job registered in a queue, and more details will be described later. If there is no waiting job for execution (step S117: No), the control unit C1 returns to step S103, shown in FIG. 6, via “Y” and waits for a new job entry through repeating the operations in steps S103 to S116.

When a job to be executed is confirmed in step S116 or S117, the control unit C1 confirms whether the job can be executed or not in mode D (the job mode which does not use the fixing unit of the image forming device or the bookbinding device of the post-processor) (step S118).

If the job is an executable job in mode D, for example, FAX transmission or the like (step S118: Yes), the control unit C1 proceeds to step S119.

In step S119, a job which does not use the heating section or the fixing unit is executed. When the job is executed, the control unit C1 proceeds to step S130.

In step S130, the control unit C1 confirms whether power is off, and if the power is off (step S130: Yes), the control unit C1 terminates the operation of the image forming system (step S131). If the power is not OFF (step S130: No), the control unit C1 returns to step S103 via “Y” to wait for a job entry through executing the process from step S103 to step S116.

If the job is not executable in mode D (step S118: No), the control unit C1 confirms whether the job is executable in mode C (the job mode which does not use the fixing unit of the image forming devices and uses the heating section of the post-processor) (step S120).

If the job is a job executable in mode C, for example, bookbinding on the offline basis or the like (step S120: Yes), the control unit C1 further confirms whether or not the heating section temperature flag is ON (step S121).

If the heating section temperature flag is ON (step S121: Yes), the control unit C1 proceeds to step S122. In step S122, a job which uses the heating section and does not use the fixing unit is executed. When the job is executed, the control unit C1 proceeds to step S129.

If the heating section temperature flag is OFF (step S121: No), the control unit C1 prohibits execution of the job and proceeds to step S123. In step S123, the control unit C1 registers the job prohibited to be executed in a queue, and returns to step S103 via “Y”. Thereafter, the process from step S103 to step S117 is executed, and the registered job in the queue, as a waiting job for execution, is executed when the heating section reaches a temperature at which job execution is permitted. The job executed then is deleted from the queue.

In step S120, if the job is not executable in mode C (step S120: No), the control unit C1 confirms whether the job is executable or not in mode B (the job mode which uses the fixing unit of the image forming devices and uses the heating section of the post-processor) (step S124).

If the job is a job executable in mode B, for example, copying that does not require bookbinding, (step S124: Yes), the control unit C1 further confirms whether the fixing unit temperature flag is ON or not (step S125).

If the fixing unit temperature flag is ON (step S125: Yes), the control unit proceeds to step S126. In step S126, the job that uses the fixing unit and does not use the heating section is executed. When the job is executed, the control unit C1 proceeds to step S129.

If the fixing unit temperature flag is ON (step S125: No), the control unit C1 prohibits execution of the job and proceeds to step S123. In step S123m the control unit C1 registers the job prohibited to be executed in a queue and returns to step S103 via “Y”.

In step S124, if the job is not executable in mode B (step S124: No), the control unit C1 determines that the execution mode for this job is mode A, and confirms whether the fixing unit temperature flag is ON or not (step S127).

If the fixing unit temperature flag is ON (step S127: Yes), the control unit C1 proceeds to step S128. In step S128, the control unit C1 further confirms whether the heating section temperature flag is ON or not. Herein, the heating section temperature flag is ON (step S128: Yes), the control unit C1 proceeds to step S129, and the job which uses the fixing unit and the heating section is executed in step S129. When the job is executed, the control unit C1 proceeds to step S130.

If the fixing unit temperature flag is OFF (step S125: NO), the job is prohibited to be executed and the control unit C1 proceeds to step S123. In step S123, the control unit C1 registers the job prohibited to be executed in a queue, and returns to step S103 via “Y”.

In step S127, if the fixing unit temperature flag is OFF (step S127: No), or the heating section temperature flag is OFF in step S128 (step S128: No), the control unit C1 prohibits execution of the job and proceeds to step S123. In step S123, the control unit C1 registers the job prohibited to be-executed in a queue, and returns to step S103 via “Y”.

As described above, if an inputted job cannot be executed because the fixing unit or the respective heating units of the bookbinding unit are under warm-up state, the control unit C1 can register the job in a queue and performs control to automatically execute the job when warm-up required for execution of the job and the flag/flags become ON state.

In the image forming system in the present embodiment, each time the fixing unit of the image forming device and the heating units of the post-processor reach the respective set temperatures and the respective temperature flags become ON state, regardless whether a user actually has input a job or not, the control unit determines currently executable jobs out of all jobs which can be inputted, based on the temperature flags, updates the mode for executable jobs, and displays it. And, when a job is input via an input section, the control unit confirms the mode to execute the job, permits execution of the job if conditions required for execution of the job are satisfied, and registers the job in a queue if these conditions are not satisfied. Thereafter, as warm-up progresses, when the fixing unit of the image forming device or the heating units of the bookbinding device reach a predetermined temperature and the conditions required for execution of the job are satisfied, the control unit permits execution of the job.

Whether a job is executable or not can be determined by referring to ON/OFF state of the fixing unit temperature flag and the heating section temperature flags without detecting the temperatures of the fixing unit and the respective heating units of the bookbinding unit each time a job is entered. However; it is also possible to determine whether a job is executable or not, by detecting whether the fixing unit and the bookbinding unit have reached the respective predetermined temperatures by temperature detecting units each time a job is entered, without setting flags. Further, although the job input section in the present embodiment is, for example, an operation panel via which a user inputs a job, the input section is not limited to this and may be an interface with an external equipment or network, which allows job entry from a host such as a PC via a network or the like.

As described above, the image forming system in the present embodiment, even if warm-up of the fixing unit or the bookbinding unit of the post-processor is not completed yet, jobs other than those which use the fixing unit or the bookbinding unit are permitted to be executed. Accordingly, the image forming system shortens waiting time for a user, and allows the user to know executable jobs at any time, providing high usability.

In the above embodiment, the control unit of the image forming device is implemented by a control section that controls the operation of the image forming system, based on the temperature of the fixing unit of the image forming device and the temperatures of the heating units of the post-processor. However, functions of the above control unit may be shared by the control unit of the image forming device and the control unit of the post-processor.

Further, in the above embodiment, the bookbinding unit of the post-processor has been described, taking an example of a structure which includes heating units for melting hot-melt of a binding tape coated with a hot-melt type adhesive. However, the invention can also be applied to, for example, a bookbinding unit having a structure which closes a sheet bundle by coating glue or adhesive heated by a heating section at the edge of the sheets and pressing the sheet bundle of the stacked sheets, or a bookbinding unit having a structure which melts glue or adhesive by coating glue or adhesive at the edge of sheets and heating the sheet bundle of stacked sheets.

In accordance with the present embodiment, the following effects can be obtained.

Since it is determined whether a job can be executed or not, based on a first temperature related information related to the temperature of the heating section of a post-processor and based on the content of the entered job, even if the temperature of the heating section of the post-processor has not reached a predetermined temperature, the job can be executed depending on the content. Therefore, it is possible to shorten waiting time for a user for job execution, and thus an image forming system or a user-friendly image forming device can be provided.

Since it is determined whether a job can be executed or not, based on a first temperature related information related to the temperature of the heating section of a post-processor, a second temperature related information related to the temperature of the fixing section of an image forming device, and the content of the entered job, even if one of the temperature of the heating section of the post-processor and the temperature of the fixing section of the image forming device has not reached a predetermined temperature, the job can be executed depending on the content. Therefore, it is possible to shorten the waiting time for a user for job execution, and thus an image forming system or a user-friendly image forming device can be provided.

Based on completion of warm-up of the fixing section of the image forming device, it is possible to determine whether a job can be executed or not. Therefore, for example, even when warm-up of the fixing section of the image forming device is not completed yet, if an inputted job does not use the fixing section of the image forming device, then the job can be determined to be executable, waiting time for the user for job execution can be shortened, and thus a user-friendly image forming system can be provided.

If the fixing section of the image forming device has not reached the predetermined temperature, a job which uses the fixing section is prohibited to be executed. Accordingly, fixing operation can be prevented in a state where the fixing section has not reached the predetermined temperature required for fixing an image on a recording medium to the recording medium. Thus, while suppressing a drop in image quality, a user-friendly image forming system can be provided.

Even when the fixing section of the image forming device has not reached the predetermined temperature, if an inputted job does not use the fixing section of the image forming device, the job can be permitted to be executed, providing a user-friendly image forming system.

When the fixing section of the image forming device has not reached the predetermined temperature for it and the heating section of the post-processor has not reached the predetermined temperature for it, all jobs inputted via the input section are prohibited to be executed. Therefore, it is possible to prevent fixing operation in a state where the fixing section has not reached the predetermined temperature necessary for the fixing section to fix an image on the recording medium to the recording medium, and it is also possible to prevent performing post-processing which needs heat, in a state where the temperature of the heating section of the post-processor has not reached the predetermined temperature. In such a way, while suppressing a drop in the quality of image and post-processing, a user-friendly image forming system can be provided.

Even when the heating section of the post-processor has not reached the predetermined temperature, if an inputted job is a job which does not use the heating section of the post-processor, the job is permitted to be executed, and a user-friendly image forming system can be provided.

When the fixing section of the image forming device has reached the predetermined temperature for it, and the heating section of the post-processor has reached the predetermined temperature for it, all jobs are permitted to be executed, providing a user-friendly image forming system with a simple structure.

When the fixing section of the image forming device has not reached the predetermined temperature, all jobs are prohibited to be executed. Accordingly, fixing operation can be prevented in a state where the fixing section has not reached the temperature necessary for the fixing section to fix an image on the recording medium to the recording medium, providing a user-friendly image forming system with a simple structure.

Based on the completion of warm-up of the heating section of the post-processor, a job can be determined to be executable or not. Therefore, for example, even when warm-up of the heating section of the post-processor is not yet completed, if an inputted job is one that does not use the heating section of the post-processor, the job can be determined to be executable. In such a way, waiting time for the user for job execution can be shortened, and a user-friendly image forming system can be provided.

When the heating section of the post-processor has not reached the predetermined temperature, a job which uses the heating section is prohibited to be executed. Accordingly, it is possible to prevent performing of post-processing, which requires heating, in a state where the temperature of the heating section has not reached the predetermined temperature, thereby suppressing a drop in the quality of post-processing and providing a user-friendly image forming system.

A user-friendly image forming system can be obtained having a post-processor which melts adhesive and bind recording media.

By incorporating a control section into an image forming device, the structure of a post-processor can be simplified, providing a user-friendly image forming system.

Since executable jobs are determined based on the first temperature related information related to the temperature of the heating section of the post-processor, even when the temperature of the heating section of the post-processor has not reached the predetermined temperature, a job can be executed depending on the content of the job, which shortens waiting time for the user for job execution, providing a user-friendly image forming system or an image forming device.

Executable jobs are also determined based on the first temperature related information related to the temperature of the heating section of the post-processor, the second temperature related information related to the temperature of the fixing section of the image forming device, and the content of each inputted job. Therefore, even when one of the temperature of the heating section of the post-processor and the temperature of the fixing section of the image forming device has not reached the predetermined temperature, a job can be executed depending on the content of the job, which shortens waiting time for the user for job execution, providing a user-friendly image forming system.

Since executable jobs can be decided based on the completion of warm-up of the fixing section of the image forming device, even when, for example, warm-up of the fixing section of the image forming device is not yet completed, if an inputted job is one that dose not use the fixing section of the image forming device, then the job can be determined to be executable, which shortens waiting time for the user for job execution, providing a user friendly image forming system.

When the fixing section of the image forming device has not reached the predetermined temperature, since a job is prohibited to be executed which uses the fixing section, if an inputted job is one that uses the fixing section of the image forming device, it is possible to prohibit the job from being executed. Thus, it is possible to prevent fixing operation in a state where the fixing section has not reached a temperature necessary for a toner image transferred, onto a recording medium, to be melt and fixed, providing a user friendly image forming system.

Even when the fixing section of the image forming device has not reached the predetermined temperature, if an inputted job is one that does not use the fixing section of the image forming device, the job can be permitted to be executed, providing a user friendly image forming system.

When the fixing section of the image forming device has not reached the predetermined temperature for it and the heating section of the post-processor has not reached the predetermined temperature for it, any job inputted via the input section is prohibited to be executed. Accordingly, it is possible to prevent fixing operation in a state where the fixing section has not reached the temperature necessary to fix an image on a recording medium to the recording medium, and is it also possible to prevent performing post-processing, which requires being heated, in a state where the temperature of the heating section of the post-processor has not reached the predetermined temperature, suppressing a drop in the quality of post-processing and providing a user friendly image forming system.

Even when the heating section of the post-processor has not reached the predetermined temperature, if an inputted job is one that does not use the heating section of the post-processor, the job can be permitted to be executed, thus a user friendly image forming system being provided.

When the fixing section of the image forming device has reached the predetermined temperature for it, and the heating section of the post-processor has reached the predetermined temperature for it, any job is permitted to be executed. Accordingly, even when one of the temperature of the fixing section of the image forming device and the temperature of the heating section of the post-processor has not reached the predetermined temperature, a job can be executed depending on the content of the job, or, for example, even when warm-up of the fixing section of the image forming device is not yet completed, if an inputted job is one that does not use the fixing section of the image forming device, the job can be determined to be executable, thus shortening waiting time for the user for job execution and providing a user friendly image forming system.

It is possible to decide executable jobs based on completion of warm-up of the heating section of the post-processor, for example, even when warm-up of the heating section of the post-processor is not yet completed, if a job inputted is one that does not use the heating section of the post-processor, the job can be determined to be executable, and waiting time for the user is shortened. When an executable job, which is decided based on the first temperature related information related to the temperature of the heating section, or, the first temperature related information and the second temperature related information related to the temperature of the fixing section, or, the first temperature related information and the second temperature related information indicating the completion of the warm-up of the fixing section related to the temperature of the fixing section, is inputted, the job can be determined to be executable. Accordingly, it shortens waiting time for the user for job execution, providing a user friendly image forming system.

When the heating section of the post-processor has not reached the predetermined temperature, since execution of a job that uses the heating section is prohibited, it is possible to prevent performing post-processing in a state where the temperature of the heating section has not reached the predetermined temperature. Thus, while suppressing a drop in the quality of post-processing, a user friendly image forming system can be provided.

At least, based on the first temperature related information related to the temperature of the heating section of the post-processor, executable jobs are displayed on the display section, a user can recognize executable jobs, and a user friendly image forming system can be provided.

It is possible to provide a user friendly image forming system which has a post-processor for binding recording media by melting adhesive.

By incorporating a control section into the image forming device, the structure of the post-processor can be simplified and a user friendly image forming system can be provided.

As a job is determined to be executable or not, based on the first temperature related information related to the temperature of the heating section of the connected post-processor and the content of the job, even when the temperature of the heating section of the post-processor has not reached the predetermined temperature, the job can be determined to be executable depending on the content of the job, which shortens waiting time for the user for job execution, providing a user friendly image forming system.

A job is determined to be executable or not, based on the first temperature related information related to the temperature of the heating section of the post-processor, the second temperature related information related to the temperature of the fixing section of the image forming device, and the content of the job. Therefore, even when neither the temperature of the heating section of the post-processor nor the temperature of the fixing section of the image forming device has reached the predetermined temperatures, or even when one of the temperature of the heating section of the post-processor and the temperature of the fixing section of the image forming device has not reached the respective predetermined temperature, the job can be executed depending on the content of the job, which shortens waiting time for the user, providing a user friendly image forming system.

Executable jobs are decided, based on the first temperature related information related to the temperature of the heating section of the connected post-processor. Therefore, even when the temperature of the heating section of the post-processor has not reached the predetermined temperature, a job can be executed depending on the content of the job, which shortens waiting time for the user for job execution, providing a user friendly image forming system.

Based on the first temperature related information related to the temperature of the heating section of the post-processor, the second temperature related information related to the temperature of the fixing section of the image forming device, and the content of inputted jobs, executable jobs are decided. Therefore, even when neither the temperature of the heating section of the post-processor nor the temperature of the fixing section of the image forming device has reached the respective temperatures, or even when one of the temperature of the heating section of the post-processor and the temperature of the fixing section of the image forming device has not reached the respective predetermined temperature, a job can be executed depending on the content of the job, which shortens waiting time for the user, providing a user friendly image forming system.

1. An image forming system, comprising:
an image forming device having an input section for inputting a job;
a post-processor for post-processing of a recording medium on which an image has been formed by the image forming device, the post-processor having a heating section and a first temperature detection section for detecting a temperature of the heating section; and
a control section that determines whether a job inputted via the input section is executable or not, based on first temperature-related information related to a temperature of the heating section, the temperature being detected by the first temperature detection section, and a content of the inputted job.

2. The image forming system of claim 1, wherein:
the image forming device includes a fixing section for fixing an image on a recording medium by heating and a second temperature detection section for detecting a temperature of the fixing section; and
the control section determines whether the inputted job is executable or not, based on the first temperature related information, second temperature related information related to a temperature of the fixing section, the temperature being detected by the second temperature detection section, and the content of the inputted job.

3. The image forming system of claim 2, wherein the second temperature related information indicates completion of warm-up of the fixing section.

4. The image forming system of claim 2, wherein the control section prohibits execution of a job that uses the fixing section, if the temperature of the fixing section has not reached a predetermined temperature.

5. The image forming system of claim 4, wherein the control section permits execution of a job that does not use the fixing section, if the temperature of the heating section has reached a predetermined temperature.

6. The image forming system of claim 2, wherein the control section prohibits execution of any job that is inputted via the input section, if the temperature of the fixing section has not reached the predetermined temperature and the temperature of the heating section has not reached the predetermined temperature.

7. The image forming system of claim 2, wherein the control section prohibits execution of a job that uses the heating section and permits execution of a job that does not use the heating section, if the temperature of the heating section has not reached the predetermined temperature and the temperature of the fixing section has reached the predetermined temperature.

8. The image forming system of claim 2, wherein the control section permits execution of any job, if the temperature of the fixing section has reached the predetermined temperature and the temperature of the heating section has reached the predetermined temperature.

9. The image forming system of claim 2, wherein the control section prohibits execution of any job, if the temperature of the fixing section has not reached the predetermined temperature.

10. The image forming system of claim 1, wherein the first temperature related information indicates completion of warm-up of the heating section.

11. The image forming system of claim 1, wherein the control section prohibits execution of a job that uses the heating section, if the temperature of the heating section has not reached the predetermined temperature.

12. The image forming system of claim 1, wherein the post-processor comprises a bookbinding device and the heating section melts adhesive for binding plural recording mediums.

13. The image forming system of claim 1, wherein the control section is provided in the image forming device.

14. An image forming system, comprising:
an image forming device having an input section for inputting a job,
a post-processor that performs post-processing of a recording medium on which an image has been formed by the image forming device, the post-processor having a heating section and a first temperature detecting section for detecting a temperature of the heating section; and
a control section that decides an executable job, based on first temperature related information related to a temperature of the heating section, the temperature being detected by the first temperature detected section.

15. The image forming system of claim 14, wherein the image forming devices comprises a fixing section for fixing an image on a recording medium by heating and a second temperature detecting section for detecting a temperature of the fixing section, and the control section decides an executable job, based on the first temperature related information and second temperature related information related to a temperature of the fixing section, the temperature being detected by the second temperature detecting section.

16. The image forming system of claim 15, wherein the second temperature related information indicates completion of warm-up of the fixing section.

17. The image forming system of claim 15, wherein the control section prohibits execution of a job that uses the fixing section, if the temperature of the fixing section has not reached a predetermined temperature.

18. The image forming system of claim 15, wherein the control section permits execution of a job that does not use the fixing section, if the temperature of the heating section has reached a predetermined temperature.

19. The image forming system of claim 15, wherein the control section prohibits execution of any job inputted via the input section, if the temperature of the fixing section has not reached the predetermined temperature and the temperature of the heating section has not reached the predetermined temperature.

20. The image forming system of claim 15, wherein the control section prohibits execution of a job that uses the heating section and permits execution of a job that does not use the heating section, if the temperature of the heating section has not reached the predetermined temperature and the temperature of the fixing section has reached the predetermined temperature.

21. The image forming system of claim 15, wherein the control section permits execution of any job, if the temperature of the fixing section has reached the predetermined temperature and the temperature of the heating section has reached the predetermined temperature.

22. The image forming system of claim 14, wherein the first temperature related information indicates completion of warm-up of the heating section.

23. The image forming system of claim 14, wherein if an executable job is input via the input section, the control section controls the image forming system, based on a content of the job inputted via the input section.

24. The image forming system of claim 14, wherein the control section prohibits execution of a job that uses the heating section, if the temperature of the heating section has not reached the predetermined temperature.

25. The image forming system of claim 14, comprising a display section for displaying the executable job.

26. The image forming system of claim 14, wherein the post-processor comprises a bookbinding device, and the heating section melts adhesive for binding plural recording mediums.

27. The image forming system of claim 14, wherein the control section is arranged in the image forming device.

28. An image forming device connectable with a post-processor that performs post-processing of a recording medium, comprising:
an input section for inputting a job; and
a control section that determines whether a job inputted via the input section can be executed or not, based on first temperature related information related to a temperature of a heating section provided in the post-processor and a content of the job.

29. The image forming device of claim 28, comprising a fixing section for fixing an image on a recording medium by heating.

30. The image forming device of claim 29, comprising a second temperature detecting section for detecting a temperature of the fixing section, wherein the control section determines whether the job can be executed or not, based on the first temperature related information and second temperature related information related to a temperature of the fixing section, the temperature being detected by the second temperature detecting section.

31. An image forming device connectable with a post-processor that performs post-processing of a recording medium, comprising:
an input section for inputting a job; and
a control section that decides an executable job inputted via the input section, based on first temperature related information related to a temperature of a heating section provided in the post-processor and a content of the job.

32. The image forming device of claim 31, comprising a fixing section for fixing an image on a recording medium by heating.

33. The image forming device of claim 32, comprising a second temperature detecting section for detecting a temperature of the fixing section, wherein the control section decides an executable job, based on the first temperature related information and second temperature related information related to a temperature of the fixing section, the temperature being detected by the second temperature detecting section.
